(19) United States
(12) Patent Application Publication
(10) Pub. No.: US 2023/0399116 A1
(43) Pub. Date: Dec. 14, 2023

(54) ELECTRICAL SUPPLY SYSTEM OF AN ELECTRICAL PROPULSION SYSTEM OF AN AIRCRAFT

(71) Applicant: AIRBUS OPERATIONS (S.A.S.), Toulouse (FR)

(72) Inventor: Jean-François ALLIAS, Toulouse (FR)

(21) Appl. No.: 18/328,679

(22) Filed: Jun. 2, 2023

(30) Foreign Application Priority Data
Jun. 9, 2022 (FR) 2205518

(51) Int. Cl. B64D 27/24; B60L 50/70; B64D 33/08; B60L 58/33; B64D 35/02; B64D 35/08; H01M 8/04111; H01M 8/04014; H02P 25/22; H02P 29/028

(52) U.S. Cl. CPC B64D 27/24; B60L 50/70; B64D 33/08; B60L 58/33; B64D 35/02; B64D 35/08; H01M 8/04111; H01M 8/04014; H02P 25/22; H02P 29/028; B60L 2200/10; H01M 2250/20

(57) ABSTRACT

The electrical supply system (10) of an electrical propulsion system (4) of an aircraft (1) includes: two first sets of fuel cells (FC11, FC12), configured to supply electrically an electric motor driving a propulsion propeller; a first compressor (C1) configured to supply compressed air to at least part of the at least two first sets of fuel cells (FC11, FC12); and a first electric motor (M1) designed to drive the first compressor. The first electric motor (M1) includes electrical windings (W1a, W1b), each electrical winding supplied electrically by a set of distinct fuel cells from amongst the at least two first sets of fuel cells (FC11, FC12).

### RELATED APPLICATION

This application incorporates by reference and claims priority to French patent application 2205518, filed Jun. 9, 2022.

### TECHNICAL FIELD

The invention relates to the field of aerodynamic thrust propulsion of aircraft using electric motors.

### BACKGROUND OF THE INVENTION

An aircraft with electrical propulsion comprises at least one electrical propulsion system. According to one embodiment, an electrical propulsion system of an aircraft comprises fuel cells which supply electricity an electric motor or a set of electric motors which drive a propulsion propeller(s). For reasons of safety of operation, a propulsion system of this type comprises at least two sets of fuel cells to supply electricity to an electric motor or a set of electric motors which drive the propulsion propeller(s). If one of the sets of fuel cells is faulty, the propulsion propeller(s) continues to be driven by the other set of fuel cells, although at a reduced power.

To operate, a set of fuel cells receives as inputs hydrogen (H₂) and oxygen (O₂). The fuel cells convert into electricity chemical energy resulting from a reaction of hydrogen in the presence of oxygen. Hydrogen is generally obtained from a hydrogen tank on board the aircraft. Oxygen is taken from ambient (atmospheric) air that has sufficient oxygen for the fuel cells. An oxygen supply tank is not needed on the aircraft. A compressor compresses ambient air and the compressed air is supplied to the input(s) to the sets of fuel cells to supply oxygen to the set of fuel cells. The compressor is generally driven by an electric motor. To obtain better performance, the compressor is for example a turbo-compressor.

A conventional solution consists of associating a compressor with each set of fuel cells, and supplying the electric motor which drives the compressor with electricity produced by the set of fuel cells. If the set of fuel cells is faulty, the electric motor which drives the compressor is no longer powered and does not drive the compressor. However, this is not a problem in that the set of fuel cells is already faulty.

### SUMMARY OF THE INVENTION

As previously indicated, each electrical propulsion system of the aircraft comprises at least two sets of fuel cells. The number of sets of fuel cells can be even greater, depending on the power required for the propulsion of the aircraft. Since a compressor is associated with each set of fuel cells, the aircraft comprises a significant number of compressors, to which there correspond a large mass and spatial requirement. Consequently, it would be desirable to reduce the number of compressors.

A solution envisaged by the inventor would consist of using a single compressor connected to a plurality of sets of fuel cells in order to supply them with compressed air. An electric motor driving the compressor would be supplied electrically by one of the sets of fuel cells. If the set of fuel cells were faulty, the electrical supply of the electric motor would be switched to another set of fuel cells to which the compressor supplies compressed air. This solution makes it possible to reduce the number of compressors on board the aircraft, and consequently their mass and spatial requirement. However, if the electric motor supplying the compressor were faulty, or if a controller of the electric motor were faulty, none of the sets of fuel cells connected to this compressor would receive compressed air. Consequently, a simple fault of the electric motor or its controller would give rise to a fault of all of the sets of fuel cells connected to this compressor. This would not be acceptable from the point of view of the availability of the propulsion system of the aircraft.

The present invention may be embodied to provide a solution to this problem. It concerns an electrical supply system of an electrical propulsion system of an aircraft, the electrical supply system comprising: at least two sets of fuel cells, including at least two first sets of fuel cells, designed to supply electrically an electric motor or a set of electric motors driving a propulsion propeller(s); a first compressor configured to supply compressed air to at least part of the at least two first sets of fuel cells; and a first electric motor designed to drive the first compressor.

The electrical supply system is distinguished in that the first electric motor designed to drive the first compressor comprises at least two electrical windings, each electrical winding being supplied electrically by means of a distinct set of fuel cells from amongst the at least two first sets of fuel cells.

Thus, the invention makes it possible to have a compressor which is common to at least two sets of fuel cells, and thus avoid the added mass and space needed to accommodate multiple similar compressors on the aircraft. Since the compressor is a mechanical device, its probability of becoming faulty is low enough to be acceptable from the point of view of availability of the propulsion system of the aircraft. Since the electric motor which drives the compressor comprises at least two electrical windings which are supplied electrically by means of distinct sets of fuel cells, the electric motor can continue to operate with reduced power if one of the electrical windings or a controller supplying one of the electrical windings electrically is faulty. This makes it possible to reasonably guarantee the availability of the propulsion system of the aircraft.

According to a first configuration, the first compressor is configured to supply compressed air to two of said sets of fuel cells, and the first electric motor which is designed to drive the first compressor comprises two electrical windings which are each supplied electrically by means of one of said two sets of fuel cells.

According to a second configuration, the first compressor is configured to supply compressed air to three of said sets of fuel cells, and the first electric motor, which is designed to drive the first compressor, comprises three electrical windings which are each supplied electrically by means of one of said three sets of fuel cells.

According to one embodiment, the electrical supply system comprises: at least four sets of fuel cells, including said at least two first sets of fuel cells, as well as at least two second sets of fuel cells, these at least four sets of fuel cells being designed to supply electrically the electric motor or the set of electric motors driving the propulsion propellers; a second compressor configured to supply compressed air to at least part of the at least two second sets of fuel cells; and a second electric motor which is designed to drive the second compressor, the second electric motor comprising at least two electrical windings, each electrical winding being supplied electrically by means of a distinct set of fuel cells from amongst the at least two second sets of fuel cells.

The compressor may be a turbo-compressor.

According to a particular embodiment, the electrical supply system additionally comprises a system for cooling at least part of the at least two first sets of fuel cells, this cooling system comprising a first fan which comprises at least two electrical windings, each electrical winding of the first fan being supplied electrically by means of a distinct set of fuel cells from amongst the at least two first sets of fuel cells.

In the particular embodiment, according to the first configuration, the cooling system is configured to cool two sets of fuel cells, and the first fan comprises two electrical windings which are each supplied electrically by means of one of said two sets of fuel cells.

In the particular embodiment, according to the second configuration, the cooling system is configured to cool three sets of fuel cells, and the first fan comprises three electrical windings which are each supplied electrically by means of one of said three sets of fuel cells.

According to one embodiment, the cooling system additionally comprises a second fan which is designed to cool at least part of the at least two second sets of fuel cells, the second fan comprising at least two electrical windings, each electrical winding of the second fan being supplied electrically by means of a distinct set of fuel cells from amongst the at least two second sets of fuel cells.

The invention also relates to an aircraft comprising a system of this type for electrical supply of an electrical propulsion system.

### SUMMARY OF FIGURES

The invention will be better understood by reading the following description and examining the appended figures.

FIG. 1 is a view of an aircraft comprising an electrical supply system of an electrical propulsion system.

FIG. 1A illustrates schematically a first embodiment of an electrical propulsion system of an aircraft.

FIG. 1B illustrates schematically a second embodiment of an electrical propulsion system of an aircraft.

FIG. 2 illustrates schematically an electrical supply system of an electrical propulsion system of an aircraft, according to a first embodiment of the invention.

FIG. 3 illustrates schematically an electrical supply system of an electrical propulsion system of an aircraft, according to another embodiment of the invention.

FIG. 4 illustrates schematically an electrical supply system of an electrical propulsion system of an aircraft, according to another embodiment of the invention.

FIG. 5 illustrates schematically an electrical supply system of an electrical propulsion system of an aircraft, according to another embodiment of the invention.

FIG. 6 illustrates schematically an electrical supply system of an electrical propulsion system of an aircraft, according to another embodiment of the invention.

### DETAILED DESCRIPTION

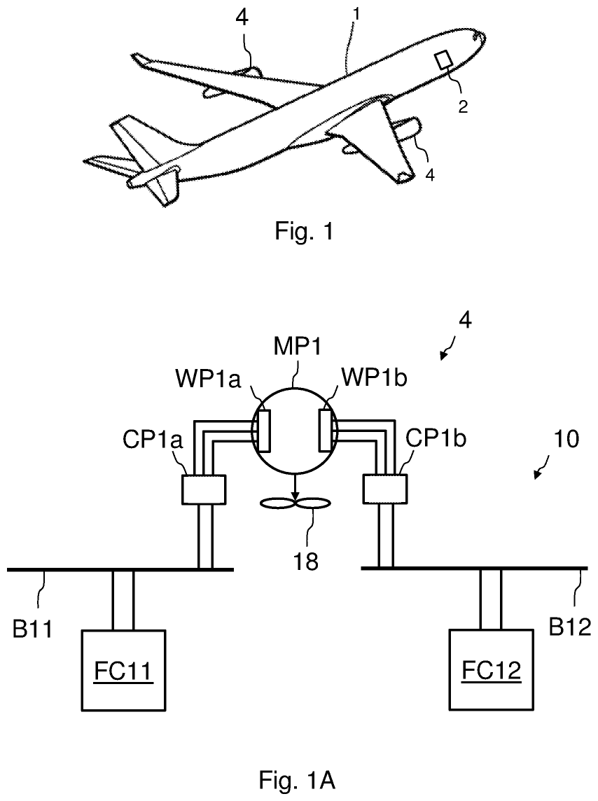

The aircraft 1 represented in FIG. 1 comprises an electrical propulsion systems 4. According to a first embodiment illustrated in FIG. 1A, each electrical propulsion system 4 comprises an electric motor MP1 comprising two independent electrical windings WP1a and WP1b. The independent electrical windings are electrically isolated in the sense that one winding is not conductively coupled to the other winding, even though there may be electromagnetic interaction between the windings mounted to the same motor.

The electric motor MP1 is a propulsion motor for the aircraft and is coupled mechanically to a propulsion propeller 18 of the aircraft. The electric propulsion motor MP1 is designed to rotate the propulsion propeller(s) 18 during its operation. The aircraft also comprises an electrical supply system 10, which is designed to supply the electrical propulsion motor MP1 electrically. In a non-limiting example of the invention, the electrical supply system 10 is for example installed in an avionic bay 2 of the aircraft. The electrical supply system 10 comprises at least two first sets of fuel cells FC11 and FC12 designed to supply the electric propulsion motor MP1 electrically. The two electrical windings WP1a and WP1b of the electric propulsion motor MP1 are each supplied electrically by means of a distinct set of fuel cells from amongst the at least two first sets of fuel cells FC11 and FC12. Thus, the electrical winding WP1a is supplied with power by the set of fuel cells FC11, by means of a controller CP1a, and the electrical winding WP1b is supplied with power by the set of fuel cells FC12, by means of a controller CP1b. The electrical propulsion system 4 and the electrical supply system 10 have redundancy and segregation which makes it possible to maintain the availability of operation, although with reduced power, of the electrical propulsion system 4, in the case of a simple fault, for example a fault of an element from amongst one of the windings WP1a and WP1b of the electric motor MP1, a set of fuel cells FC11 or FC12, a controller CP1a or CP1b, etc.

According to a second embodiment illustrated in FIG. 1B, the electrical propulsion system 4 comprises a set of electric motors MP1a, MP1b for propulsion of the aircraft. The electric motor MP1a comprises an electrical winding WP1a, and the electric motor MP1b comprises an electrical winding WP1b. The electric motors MP1a and MP1b are both coupled mechanically to the propulsion propeller 18 of the aircraft by means of a gearbox GB. These two motors are designed to rotate the propulsion propeller 18 during their operation. The electrical windings WP1a and WP1b of the electric motors MP1a and MP1b are each supplied electrically by means of a distinct set of fuel cells from amongst the at least two first sets of fuel cells FC11 and FC12. Thus, the electrical winding WP1a is supplied with power by the set of fuel cells FC11, by means of a controller CP1a, and the electrical winding WP1b is supplied with power by the set of fuel cells FC12, by means of a controller CP1b. The electrical propulsion system 4 and the electrical supply system 10 have redundancy and segregation making it possible to maintain the availability of the operation, although with reduced power, of the electrical propulsion system 4, in the case of a simple fault, for example a fault of an element from amongst one of the windings WP1a and WP1b of the electric motors MP1a, MP1b, a set of fuel cells FC11 or FC12, and a controller CP1a or CP1b. The windings WP1a are separate from those of WP1b; the electric motor MP1a is separate from electric motor MP1b, and the set of fuel cells FC11 is separate from the fuel cells FC12.

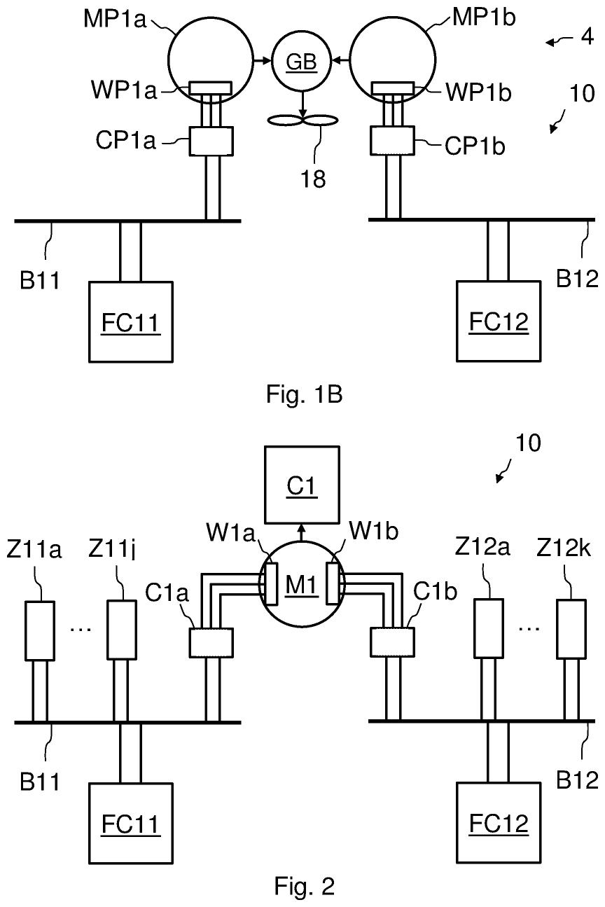

In the embodiment illustrated in FIG. 2, electrical supply system 10 comprises at least two first sets of fuel cells FC11 and FC12 designed to supply electricity to the at least one electric motor driving the propeller(s). Each set of fuel cells receives as inputs hydrogen (H₂) and oxygen (O₂). A first compressor C1 supplies compressed ambient air to the two first sets of fuel cells FC11 and FC12, to supply sufficient oxygen for the two first sets of fuel cells FC11 and FC12, to permit their operation. Hydrogen is supplied from a tank on board the aircraft. The amount of oxygen in ambient air is sufficient, such that it is not necessary to install an oxygen tank on board the aircraft.

A compressor, such as the compressor C1, compresses the ambient air before the compressed air with oxygen is ducted to the set(s) of fuel cells, to provide the set of fuel cells with sufficient oxygen to permit their operation. The first compressor C1 is coupled mechanically to a first electric motor M1. The assembly formed by the first electric motor M1 and the first compressor C1 is also known as the motor-compressor.

The first electric motor M1 comprises two electrical windings W1a and W1b, each electrical winding being supplied electrically by a respective set of fuel cells in the at least two first sets of fuel cells FC11 and FC12. For example, the electrical winding W1a is supplied with electrical power by the set of fuel cells FC11 and electrical winding W1b is supplied with power by the set of fuel cells FC12. Controller CP1a controls the supply of electricity from fuel cells FC11 to electrical windings W1a, and controller CP1b controls the supply of electricity from fuel cells FC12 to windings W1b.

According to a non-limiting example of the invention, other electrical charges Z11a Z11j are supplied electrically by the set of fuel cells FC11, for example by means of a set of electrical distribution bars B11, and other electrical charges Z12a Z12k are supplied electrically by the set of fuel cells FC12, for example by means of a set of electrical distribution bars B12. For the sake of clarity of the figure, the electrical propulsion system 4 is not represented. It is for example similar to one of the electrical propulsion systems illustrated in FIGS. 1A and 1B.

In normal operation, when the sets of fuel cells FC11 and FC12 are producing electricity, the two electrical windings W1a and W1b of the first electric motor M1 are supplied electrically from a respective fuel cell FC11 ro FC12, respectively under the control, respectively, of the controllers C1a and C1b. The first electric motor M1 to operate at its nominal power and to drive the first compressor C1, which can thus operate at its nominal power.

If one of the two sets of fuel cells is faulty, for example FC11, only the electrical winding W1b of the electric motor M1 is supplied with power, by the other set of fuel cells FC12. Consequently, the electric motor M1 may operate at only at half its nominal power because it is driven by only W1b and not by W1a. Similarly, the compressor C1, driven by the electric motor M1, may only operate at half its nominal power. The reduction in power driving compressor C1 should not cause a problem because, in such circumstances, only the set of fuel cells FC12 is being fed compressed ambient air and no compressed air is fed to the non-working fuel cells FC11. Also, the electricity supplied to the at least one propulsion from motor M1 is reduced because electrical power is supplied only from the set of fuel cells FC12 to winding W1b. Even with the reduced electricity, which allows this propulsion motor to continue to operate, although at a power level which is reduced by half compared with its nominal power.

If one of the controllers C1a or C1b is faulty, or if one of the electrical windings W1a or W1b of the first electric motor is faulty, the first electric motor M1 is supplied electrically by a single one of the two windings. As in the preceding case of a fault, it can operate only at half its nominal power, as can the first compressor C1. Consequently, the two sets of fuel cells FC11 and FC12 then receive a flow of air corresponding to substantially half the flow of air necessary for their nominal operation. These two sets of fuel cells FC11 and FC12 can thus supply substantially half their nominal power, which allows the propulsion motor to continue to operate, although at a power level which is reduced substantially by half compared with its nominal power.

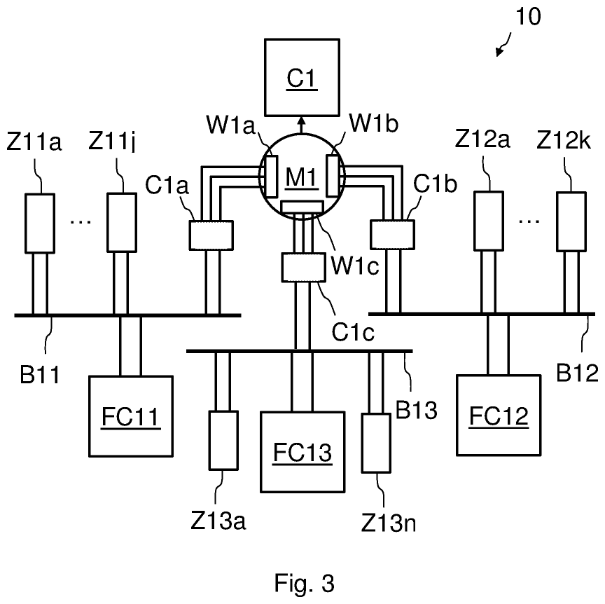

In the embodiment represented in FIG. 3, the electrical supply system 10 also comprises a third first set of fuel cells FC13, and the electric motor M1 comprises a third electrical winding W1c, which is supplied electrically by the set of fuel cells FC13, by means of a controller C1c. According to a non-limiting example of the invention, other electrical charges Z13a . . . Z13n are supplied electrically by the set of fuel cells FC13, for example by means of a set of electrical distribution bars B13. For the sake of clarity of the figure, the electrical propulsion system 4 is not represented. It is for example similar to one of the electrical propulsion systems illustrated in FIGS. 1A and 1B. Advantageously, the electrical propulsion system similar to that illustrated in FIG. 1A is then such that the electrical propulsion motor MP1 also comprises a third electrical winding WP1c. Advantageously, the electrical propulsion system similar to that illustrated in FIG. 1B is then such that it also comprises a third electric motor MP1c, which is also coupled to the gearbox GB.

If one of the three first sets of fuel cells FC11, FC12, FC13 is faulty, two of the three electrical windings W1a, W1b, W1c of the electric motor M1 continue to be supplied electrically. Consequently, the electric motor M1 operates only at two thirds of nominal power. The compressor C1, driven by the electric motor M1, also operates at only at two thirds of its nominal power. The fact that the compressor C1 operates only at two thirds of its nominal power does not cause a problem in such circumstances, since only two of the three first sets of fuel cells FC11, FC12, FC13 then need compressed air in order to operate, with one of said sets of fuel cells being faulty. The at least one propulsion motor is thus supplied electrically by two of the three first sets of fuel cells, which allows this propulsion motor to continue to operate, although with power which is reduced by a third compared with its nominal power. The same applies if one of the controllers C1a, C1b or C1c is faulty, or if one of the electrical windings W1a, W1b or W1c is faulty.

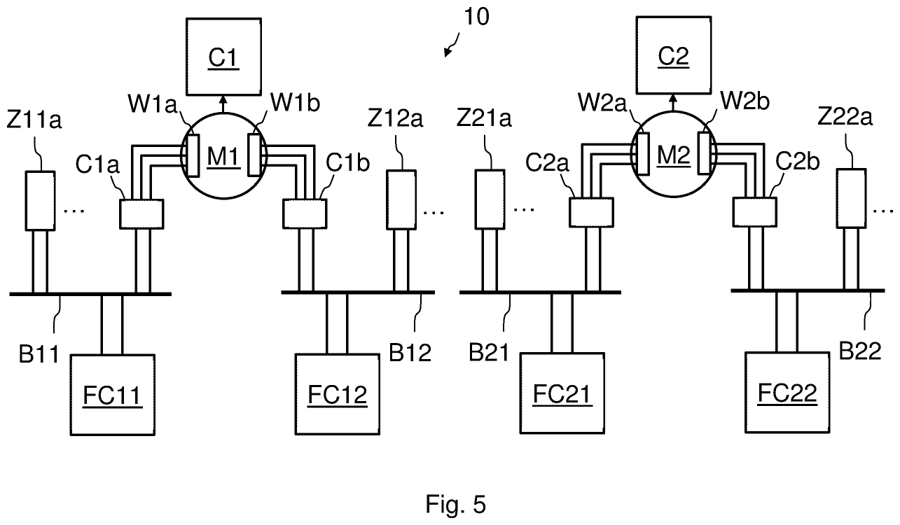

In the embodiment represented in FIG. 5, the electrical supply system 10 comprises a first part similar to the electrical supply system corresponding to the embodiment represented in FIG. 2. This first part comprises the two first sets of fuel cells FC11, FC12 and the first electric motor M1 coupled mechanically to the first compressor C1. The two first sets of fuel cells FC11 and FC12 are designed to supply electrically the at least one electric motor which drives the propulsion propeller. The first electric motor M1 comprises two electrical windings W1a and W1b, each electrical winding being supplied electrically by means of a distinct set of fuel cells from amongst the at least two first sets of fuel cells FC11 and FC12. Thus, the electrical winding W1a is supplied with power by the set of fuel cells FC11, by means of a controller C1a, and the electrical winding W1b is supplied with power by the set of fuel cells FC12, by means of a controller C1b. The electrical supply system 10 also comprises a second part which comprises two second sets of fuel cells FC21, FC22, and a second electric motor M2 which is coupled mechanically to a second compressor C2. Like the two first sets of fuel cells FC11 and FC12, the two second sets of fuel cells FC21 and FC22 are also designed to supply electrically the at least one electric motor which drives the propulsion propeller of the electrical propulsion system 4. The second electric motor M2 comprises two electrical windings W2a and W2b, each electrical winding being supplied electrically by means of a distinct set of fuel cells from amongst the at least two sets of fuel cells FC21 and FC22. Thus, the electrical winding W2a is supplied with power by the set of fuel cells FC21, by means of a controller C2a, and the electrical winding W2b is supplied with power by the set of fuel cells FC22, by means of a controller C2b.

In normal operation, the sets of fuel cells FC11, FC12, FC21 and FC22 produce electricity. Consequently, the two electrical windings W1a and W1b of the first electric motor M1 are supplied electrically, respectively by means of the controllers C1a and C1b. This allows the first electric motor M1 to operate at its nominal power, and to drive the first compressor C1, which can thus operate at its nominal power. Similarly, the two electrical windings W2a and W2b of the second electric motor M2 are supplied electrically, respectively by means of the controllers C2a and C2b. This allows the second electric motor M2 to operate at its nominal power, and to drive the second compressor C2, which can thus operate at its nominal power.

If one of the four sets of fuel cells FC11, FC12, FC21 and FC22 is faulty, that of the two compressors C1 and C2, which is normally supplied with power partly by the set of fuel cells which is faulty, can operate only at half its nominal power, as already described in the case of the embodiment illustrated in FIG. 2. This permits normal operation of the other set of fuel cells supplied with air by this compressor. Consequently, apart from the set of fuel cells which is faulty, the three other sets of fuel cells operate nominally. The at least one propulsion motor is thus supplied electrically by these three sets of fuel cells, which allows this propulsion motor to continue to operate, although with power which is reduced by a quarter compared with its nominal power.

If one of the four controllers C1a, C1b, C2a or C2b is faulty, or if one of the four electrical windings W1a, W1b, W2a or W2b is faulty, as already described in the case of the embodiment illustrated in FIG. 2, the two sets of fuel cells supplied with air by the compressor affected by the fault continue to operate with power reduced substantially by half compared with their nominal power. The two other sets of fuel cells operate at their nominal power. Consequently, the propulsion motor continues to operate, although with power which is reduced substantially by a quarter compared with its nominal power.

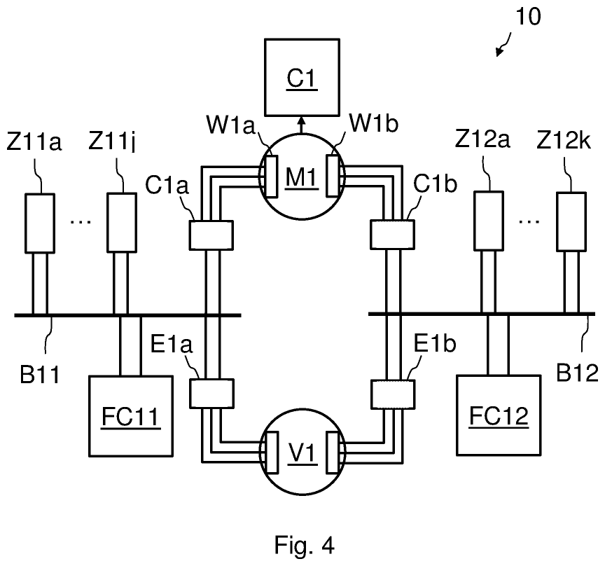

The electrical supply system 10 represented in FIG. 4 is similar to that represented in FIG. 2. It also comprises a first fan V1 which forms part of a system for cooling of the two first sets of fuel cells FC11 and FC12. This fan is for example incorporated in a heat exchanger designed to cool a heat-transfer fluid of a circuit for cooling of the two first sets of fuel cells, by exchange of heat with the air obtained from the exterior of the aircraft. Like the first electric motor M1, the first fan V1 comprises two electrical windings, each electrical winding being supplied electrically by means of a distinct set of fuel cells from amongst the at least two first sets of fuel cells FC11 and FC12. Thus, one of the electrical windings is supplied with power by the set of fuel cells FC11, by means of a controller E1a, and the other electrical winding is supplied with power by the set of fuel cells FC12, by means of a controller E1b.

The fact of using a common fan V1 for cooling of the set of fuel cells FC11 and the set of fuel cells FC12 has the advantage of reducing the mass and spatial requirement of the cooling system compared with a conventional solution, in which an independent fan would be used for cooling of each of said sets of fuel cells.

If one of the two sets of fuel cells is faulty, for example FC11, only one of the electrical windings of the first fan V1 is supplied with power, by the other set of fuel cells FC12. Consequently, the first fan V1 can operate only at half its nominal power. As a result, the cooling system can operate only at half its nominal power. This does not cause a problem in such circumstances, since only the set of fuel cells FC12 needs to be cooled, since the set of fuel cells FC11 is faulty. The at least one propulsion motor is thus supplied electrically by the set of fuel cells FC12, which allows this propulsion motor to continue to operate, although with power which is reduced by half compared with its nominal power.

If one of the controllers E1a or E1b is faulty, or if one of the electrical windings of the first fan V1 is faulty, the first fan V1 is supplied electrically by a single one of the two windings. As in the preceding case of a fault, it can operate only at half its nominal power. As a result, the cooling system can operate only at half its nominal power. This allows the two sets of fuel cells FC11 and FC12 to operate substantially at half of their nominal power, which allows the propulsion motor to continue to operate, although with power which is reduced substantially by half compared with its nominal power.

According to an embodiment not represented in the figures, the electrical supply system 10 is similar to that represented in FIG. 3, and also comprises a first fan V1 like that represented in FIG. 4. The first fan V1 comprises three electrical windings, which are supplied with power respectively by the sets of fuel cells FC11, FC12 and FC13. If one of the three first sets of fuel cells FC11, FC12, FC13 is faulty, two of the three electrical windings of the first fan V1 continue to be supplied electrically. This allows the first fan V1 to operate at two thirds of its nominal power. The fact that the fan V1 is operating at only two thirds of its nominal power does not cause a problem in such circumstances, since only two of the three first sets of fuel cells FC11, FC12, FC13 then need to be cooled in order to operate, with one of said sets of fuel cells being faulty. The at least one propulsion motor is thus supplied electrically by two of the three first sets of fuel cells, which allows this propulsion motor to continue to operate, although with power which is reduced by a third compared with its nominal power. The same applies if one of the controllers supplying the electrical windings of the first fan V1 is faulty, or if one of the electrical windings is faulty.

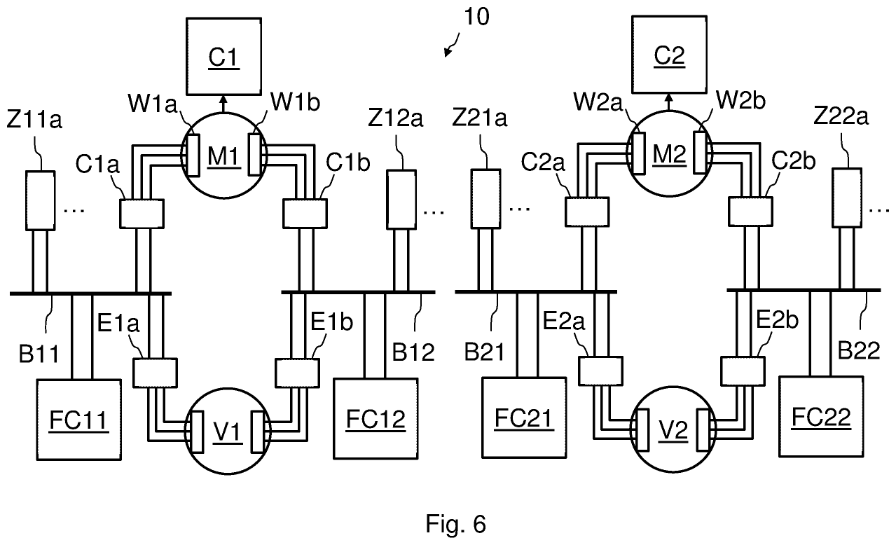

The electrical supply system 10 represented in FIG. 6 is similar to that represented in FIG. 5. It also comprises a first fan V1 which forms part of a system for cooling of the two first sets of fuel cells FC11 and FC12. This first fan is for example incorporated in a heat exchanger designed to cool a heat-exchange fluid of a circuit for cooling of the two first sets of fuel cells, by exchange of heat with the air obtained from the exterior of the aircraft. Like the first electric motor M1, the first fan V1 comprises two electrical windings, each electrical winding being supplied electrically by means of a distinct set of fuel cells from amongst the at least two first sets of fuel cells FC11 and FC12. Thus, one of the electrical windings is supplied with power by the set of fuel cells FC11, by means of a controller E1a, and the other electrical winding is supplied with power by the set of fuel cells FC12, by means of a controller E1b. Similarly, the electrical supply system 10 also comprises a second fan V2 which forms part of a system for cooling of the two second sets of fuel cells FC21 and FC22. This second fan is for example incorporated in a heat exchanger designed to cool a heat-exchange fluid of a circuit for cooling of the two second sets of fuel cells, by exchange of heat with the air obtained from the exterior of the aircraft. The second fan V2 comprises two electrical windings, with each electrical winding being supplied electrically by means of a distinct set of fuel cells from amongst the at least two second sets of fuel cells FC21 and FC22. Thus, one of the electrical windings is supplied with power by the set of fuel cells FC21, by means of a controller E2a, and the other electrical winding is supplied with power by the set of fuel cells FC22, by means of a controller E2b.

In normal operation, the sets of fuel cells FC11, FC12, FC21 and FC22 produce electricity. Consequently, the two electrical windings of the first fan V1 are supplied electrically, respectively by means of the controllers Ela and E1b. This allows the first fan V1 to operate at its nominal power. Similarly, the two electrical windings of the second fan V2 are supplied electrically, respectively by means of the controllers E2a and E2b. This allows the second fan V2 then to operate at its nominal power.

If one of the four sets of fuel cells FC11, FC12, FC21 and FC22 is faulty, the one of the two fans V1 and V2 which is normally supplied with power partly by the set of fuel cells which is faulty, can then operate only at half its nominal power, as already described in the case of the embodiment illustrated in FIG. 4. This permits normal operation of the other set of fuel cells cooled by this fan. Consequently, apart from the set of fuel cells which is faulty, the three other sets of fuel cells operate nominally. The at least one propulsion motor is thus supplied electrically by these three sets of fuel cells, which allows this propulsion motor to continue to operate, although with power which is reduced by a quarter compared with its nominal power.

If one of the four controllers E1a, E1b, E2a or E2b is faulty, or if one of the four electrical windings of the two fans is faulty, as already described in the case of the embodiment illustrated in FIG. 4, the two sets of fuel cells cooled by the fan affected by the fault continue to operate with power which is reduced substantially by half compared with their nominal power. The two other sets of fuel cells operate at their nominal power. Consequently, the propulsion motor continues to operate, although with power which is reduced substantially by a quarter compared with its nominal power.

The electrical supply of the electric motor or of the set of electric propulsion motors of the aircraft is not represented in FIGS. 2 to 6, in order not to overload these figures.

1. An aircraft comprising:
a propulsion propeller configured to provide aerodynamic thrust to propel the aircraft in flight;
an electrical propulsion system including at least one electrical propulsion motor including independent electrical windings, a first electrical winding and a second electrical winding independent of the first electrical winding, wherein the at least one electrical propulsion motor is mechanically coupled to the propulsion propeller and configured to drive the propulsion propeller,
an electrical supply system comprising:
a first set of fuel cells electrically coupled to the first electrical winding and configured to supply electrical power to the first electrical winding;
a second set of fuel cells electrically coupled to the second electrical winding and configured to supply electrical power to the second electrical winding;
a first compressor configured to supply compressed ambient air to the first set of fuel cells and the second set of fuel cells, wherein the compressed ambient air provides oxygen which reacts with hydrogen in the first and the second sets of fuel cells to generate the electrical power; and
a first electric motor mechanically coupled to drive the first compressor, the first electric motor comprising a third electrical winding electrically coupled to the first set of fuel cells and a fourth electrical winding electrically coupled to the second set of fuel cells.

2. The aircraft as in claim 1, wherein the electrical supply system further comprises a cooling system configured to cool at least part of the first and the second sets of fuel cells, the cooling system comprising a first fan including a fifth electrical winding electrically coupled to the first set of fuel cells and a sixth electrical winding electrically coupled to the second set of fuel cells.

3. An electrical supply system for an electrical propulsion system of an aircraft, the electrical supply system comprising:
a first set of fuel cells configured to supply electrical power to at least one electric propulsion motor driving a propeller configured to provide aerodynamic thrust to the aircraft;
a second set of fuel cells configured to supply electrical power to the at least one electric propulsion motor driving the propeller;
a first compressor configured to supply compressed ambient air to at least one of the first and second sets of fuel cells, wherein the compressed ambient air provides oxygen which reacts with hydrogen in the first and/or the second sets of fuel cells to generate the electrical power; and
a first electric motor configured to drive the first compressor, wherein the first electric motor includes a first electrical winding electrically coupled to the first set of fuel cells and a second electrical winding electrically coupled to the second set of fuel cells, wherein the first electrical winding is electrically isolated from the second electrical winding.

4. The electrical supply system as in claim 3, wherein the first compressor is configured to supply compressed ambient air to the first and the second sets of fuel cells.

5. The electrical supply system as in claim 3, further comprising a third set of fuel cells configured to supply electrical power to the at least one electrical propulsion motor, wherein the first compressor is configured to supply compressed air to the first, the second and the third sets of fuel cells, and the first electric motor includes a third electrical winding electrically coupled to the third set of fuel cells.

6. The electrical supply system as in claim 3, further comprising:
a third set of fuel cells configured to provide electrical power to the at least one electrical propulsion motor;
a fourth set of fuel cells configured to supply electrical power to the at least one electric propulsion motor;
a second compressor configured to supply compressed ambient air to at least one of the third and the fourth sets of fuel cells; and
a second electric motor configured to mechanically drive the second compressor, wherein the second electric motor includes a third electrical winding electrically coupled to the third set of fuel cells and a fourth electrical winding electrically coupled to the fourth set of fuel cells.

7. The electrical supply system as in claim 3, wherein the compressor includes a turbo-compressor.

8. The electrical supply system as in claim 3, further comprising:
a cooling system configured to cool at least the first and the second, sets of the fuel cells, the cooling system comprising a first fan with a fifth electrical winding electrically coupled to the first set of the fuel cells, and a sixth electrical winding electrically coupled to the second set of the fuel cells.

9. The electrical supply system of claim 6, further comprising a cooling system including:
a first fan with a fifth electrical winding electrically coupled to the first set of the fuel cells, and a sixth electrical winding electrically coupled to the second set of the fuel cells, wherein the first fan is configured to cool the first and the second sets of the fuel cells; and
a second fan configured to cool the third and the fourth sets of the fuel cells, and the second fan includes a seventh electrical winding electrically coupled to the third set of the fuel cells, and an eighth electrical winding electrically coupled to the fourth set of the fuel cells.

10. The electrical supply system of claim 5, further comprising a first fan configured to cool the first, the second and the third sets of the fuel cells, and the first fan includes an electrical motor with a fourth winding electrically powered by the first set of the fuel cells, a fifth winding electrically powered by the second set of fuel cells, and a sixth winding electrically coupled to the third set of fuel cells.

11. The electrical supply system of claim 10, further comprising:
a second fan configured to cool at least one of the first, the second and the third sets of the fuel cells, the second fan comprising a seventh winding electrically coupled to the third set of the fuel cells.

12. An electrical propulsion system of an aircraft comprising:
an electric propulsion motor configured to drive a propeller configured to provide aerodynamic thrust to the aircraft, wherein the electric propulsion motor includes a first winding and a second winding electrically isolated from the first winding;
a first set of fuel cells configured to supply electrical power to the first winding;
a second set of fuel cells configured to supply electrical power to the second winding;
a first compressor configured to supply compressed ambient air to the first set of fuel cells and the second set of fuel cells, wherein the compressed ambient air provides oxygen which reacts with hydrogen in the first and the second sets of fuel cells to generate the electrical power; and
a first electric motor configured to drive the first compressor, wherein the first electric motor includes a third electrical winding electrically coupled to the first set of fuel cells and a fourth electrical winding electrically coupled to the second set of fuel cells, wherein the fourth electrical winding is electrically isolated from the third electrical winding.

13. The electrical propulsion system of claim 12, further comprising:
a first controller configured to control application of the electrical power from the first set of the fuel cells to the first winding, and
a second controller configured to control application of the electrical power from the second set of the fuel cells to the second winding.

14. The electrical propulsion system of claim 13, further comprising:
a first fan with a fifth electrical winding electrically coupled to the first set of the fuel cells, and a sixth electrical winding electrically coupled to the second set of the fuel cells, wherein the first fan is configured to cool the first and the second sets of fuel cells.
